(19) United States
(12) Patent Application Publication
(10) Pub. No.: US 2014/0021250 A1
(43) Pub. Date: Jan. 23, 2014

(54) METHOD BY WHICH MERCHANTS CAN ASSIST CONSUMERS IN MONITORING AND MANAGING FOOD SUPPLIES

(71) Applicants: Jiajiu SHAW, Ann Arbor, MI (US); Michael Gzybowski, Ann Arbor, MI (US)

(72) Inventors: Jiajiu SHAW, Ann Arbor, MI (US); Michael Gzybowski, Ann Arbor, MI (US)

(21) Appl. No.: 13/943,878

(22) Filed: Jul. 17, 2013

Related U.S. Application Data
(60) Provisional application No. 61/673,084, filed on Jul. 18, 2012.

(51) Int. Cl. G06F 17/30

(52) U.S. Cl. CPC G06F 17/30
USPC 235/375

(57) ABSTRACT

A method by which merchants can assist consumers in monitoring and managing their food supplies, which method involves providing food items each of which have predetermined expiration dates wherein each food item is marked with a scannable code that includes at least each item's identification and each item's expiration date. Upon obtaining the food items by a customer the food items are scanned and the customer is provided with or provided with access to information including each item's identification and each item's expiration date.

### RELATED APPLICATION

The present application is based upon U.S. Provisional Application Ser. No. 61/673,084, filed Jul. 18, 2013 to which priority is claimed under 35 U.S.C. §120 and of which the entire specification is hereby expressly incorporated by reference.

### BACKGROUND

The present invention relates generally to a method that assists consumers in monitoring and managing their food supplies. The present invention further relates to a method that assist consumers in limiting the amount of their food supply items that go unused beyond the expiration dates of such food supply items.

The United States is a land of waste, particularly food waste. According to the U.S. Department of Agriculture's Food Loss Project, Americans are inclined to discard more than 25% (approximately 25.9 million tons) of all the food produced domestically, with actual estimates being 40-50% of foods they own.

According to MSN Money the average U.S. family spends about 13 percent of their overall budget on food. A family including two adults aged 19 to 50 and two children, aged 2 to 3 and 4 to 5 years old, having a liberal grocery budget totaling $220.30 per week, or about $11,500 per year. Discarding 25% of groceries purchased on such a budget results in a loss of almost $3,000 per year.

Often consumers throw out foods that have passed their expiration dates, without ever realizing the storage life of such foods have expired. In such cases the consumers simply miss the opportunity to consume such foods by missing the expiration dates.

Due to the current economic conditions, it would greatly benefit consumer budgets if the consumers could reduce the amount of foods that are unnecessarily wasted. In the case of expiration dates, many consumers would prefer to consume the foods before their storage life expires rather than throw the foods out after their storage life expires, and lose the cost of the discarded food. Although some consumers may be comfortable consuming some foods beyond their expiration dates, most everyone realizes that at some point beyond their expiration dates food are not safe to consume.

Because individual consumers purchase such a wide variety of food items, it is difficult and not practical to expect consumers to keep track of the expiration dates of all the food items they purchase.

It can be disheartening for consumers to discover that their stock of food items includes a number of food items that need to be disposed of because the expiration dates of such food items has passed.

The present invention provides a method that assists consumers in monitoring and managing their food supplies.

### BRIEF SUMMARY

According to various features, characteristics and embodiments of the present invention which will become apparent as the description thereof proceeds, the present invention provides a method by which merchants can assist consumers in monitoring and managing their food supplies, which method comprises:
providing food items each of which has predetermined expiration date;
marking each individual food item with a scannable code that includes at least each item's identification and each item's expiration date;
scanning the food items for a customer obtaining the food items; and
providing the customer with information including each item's identification and each item's expiration date.

According to one or more aspects of the invention the merchant comprises a grocery store or a retail store that sells groceries in addition to non-grocery items.

The scannable code can include an electronically scannable code or an optically scannable code, including a barcode.

According to one embodiment, the step of providing the customer with information, including each item's identification and each item's expiration date, comprises e-mailing the information to the customer or providing the customer with access to the information.

The step of providing the customer with information, including each item's identification and each item's expiration date, can comprise e-mailing the customer a data file that includes information including each item's identification and each item's expiration date.

According to one or more further embodiments the consumer can manipulate the data file as desired to print, display or process the data in an auxiliary program.

According to one embodiment of the invention the step of providing the customer with information, including each item's identification and each item's expiration date, comprises providing the information to the customer on a website.

In one embodiment the step of providing the customer with information, including each item's identification and each item's expiration date, comprises providing the customer access to a data file that includes information including each item's identification and each item's expiration date.

In one or more embodiments the consumer can manipulate the data file as desired to print, display or process the data in an auxiliary program.

In a basic embodiment the information, including each item's identification and each item's expiration date, are provided to the consumer in the form of a calendar in electronic form or hard copy.

The step of the customer obtaining the food items can include buying the food items either in person or via the internet.

### DETAILED DESCRIPTION OF THE PRESENTLY PREFERRED EMBODIMENTS

The present invention is directed to a method that assists consumers in monitoring and managing their food supplies. The present invention further relates to a method that assist consumers in limiting the amount of their food supply items that go unused beyond the expiration dates of such food supply items.

The United States Food and Drug Administration regulates the expiration dating of food items or food products.

Nevertheless food expiration date coding is a nightmare for the consumer to interpret. There is no standard. Each vendor decides how they want to do it. The FDA only has guidelines on labeling a product and the required information. This is different from an expiration date on all food products that the consumer can understand.

Food products can be divided into two main categories—refrigerated and canned. Most bakery and pharmacy related food items are “sell by” or “best by” dated, which is easy for you and Ito understand. Some refrigerated and canned manufactures use this form of dating.

Barcodes are used on nearly all products sold in grocery stores. The barcodes including information that allows grocery stores to monitor and track inventory. In addition barcodes include information regarding the sale price of items so that optical scanners at checkout lanes can be used to scan food items purchased by consumers and develop itemized receipts of food items purchased, including individual item names and costs, as well as total cost and any discounts, including discounts attributable to coupons and/or customer loyalty programs.

Barcodes are also capable of including information such as product weight, expiration date, country of origin, etc.

Many merchants, including grocery stores provide various customer loyalty programs which offer customers incentives, discounts, sale information, etc. by e-mail or check-out coupons, or other means. One such loyalty program offered by Busch's Fresh Food Market of Ann Arbor, Mich. named “My Way” tracks customer/member shopping habits, and provides customer/members with information as to individual items they regularly purchase, including updates identification as to when such regularly purchased items are on sale or discounted for the customers.

The present invention involves obtaining information from barcodes (or other optically or electronically scannable codes) when a consumer checks out purchases at a grocery store and providing the consumer with data including the items purchased and each item's expiration data.

Such data, i.e. the identification of items purchased and their individual expiration dates can be encoded in the barcodes and read by an optical scanner at the time the items are scanned at checkout.

The data, including the identification of items and their individual expiration dates can be provided organized in various formats that are convenient for the consumer which can be e-mailed to the consumer after purchase, or made available to the consumer on a website provided by the merchant or a third party associate or affiliate of the merchant.

For example, the data can be e-mailed to the consumer in the form or a word document, a spreadsheet, a printable calendar or other format that can be accessed and used by any application a consumer may have on his or her home computer, tablet computer, PDA, cell phone, etc. It is also within the scope of the present invention for the merchants to provide loyalty or registered consumers with an application by which the consumer can manipulate the data to present it in a desired format for printing or display, or for manipulating the data for purposes such as updating a running list of expiration dates, tracking costs for expired items that are discarded after their expiration date, developing meal plans for items that are not expired or soon to be expired, for developing alerts for soon to expire items, for developing shopping lists that include replenishment of items that expired, etc. It is envisioned that a vast number of applications could be developed for consumers to manipulate the combination of item identification data and expiration data.

The benefit for the consumer with the present invention is that the consumer would be provided with the ability to track expiration dates and therefore consume food items before they expire and have to be discarded for safety, thus saving food costs.

The benefit for grocery store merchants is that the consumers are likely to resupply items after their expiration dates sooner that sometime after the consumers realize the expiration dates have passed. Further the grocery store merchants can, in a way, partner with consumers as far are assisting consumers in monitoring and managing their food supplies. In addition grocery store merchants can also monitor the expiration dates of consumers' purchased items and prompt consumers to replenish such items, including offering incentives to purchase such items, thus potentially increasing sales.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

1. A method by which merchants can assist consumers in monitoring and managing their food supplies, which method comprises:
providing food items each of which has predetermined expiration date;
marking each individual food item with a scannable code that includes at least each item's identification and each item's expiration date;
scanning the food items for a customer obtaining the food items; and
providing the customer with information including each item's identification and each item's expiration date.

2. A method by which merchants can assist consumers in monitoring and managing their food supplies according to claim 1, wherein merchant comprises a grocery store or a retail store that sells groceries in addition to non-grocery items.

3. A method by which merchants can assist consumers in monitoring and managing their food supplies according to claim 1, wherein the scannable code comprises an optically scannable code.

4. A method by which merchants can assist consumers in monitoring and managing their food supplies according to claim 3, wherein the optically scannable code comprises a barcode.

5. A method by which merchants can assist consumers in monitoring and managing their food supplies according to claim 1, wherein the step of providing the customer with information including each item's identification and each item's expiration date, comprises e-mailing the information to the customer.

6. A method by which merchants can assist consumers in monitoring and managing their food supplies according to claim 1, wherein the step of providing the customer with information, including each item's identification and each item's expiration date, comprises e-mailing the customer a data file that includes information including each item's identification and each item's expiration date.

7. A method by which merchants can assist consumers in monitoring and managing their food supplies according to claim 6, wherein the consumer can manipulate the data file as desired to print, display or process the data in an auxiliary program.

8. A method by which merchants can assist consumers in monitoring and managing their food supplies according to claim 1, wherein the step of providing the customer with information, including each item's identification and each item's expiration date, comprises providing the information to the customer on a website.

9. A method by which merchants can assist consumers in monitoring and managing their food supplies according to claim 1, wherein the step of providing the customer with information, including each item's identification and each item's expiration date, comprises providing the customer access to a data file that includes information including each item's identification and each item's expiration date.

10. A method by which merchants can assist consumers in monitoring and managing their food supplies according to claim 9, wherein the consumer can manipulate the data file as desired to print, display or process the data in an auxiliary program.

11. A method by which merchants can assist consumers in monitoring and managing their food supplies according to claim 1, wherein the information including each item's identification and each item's expiration date are provided to the consumer in the form of a calendar.

12. A method by which merchants can assist consumers in monitoring and managing their food supplies according to claim 1, wherein the step of the customer obtaining the food items including buying the food items.
